(19) United States
(12) Patent Application Publication
(10) Pub. No.: US 2009/0086869 A1
(43) Pub. Date: Apr. 2, 2009

(54) METHOD AND SYSTEM OF RECEIVING TAG SIGNAL FROM RFID READER

(75) Inventors: Ji-Hoon Bae, Daejeon (KR); Hee Sook Mo, Daejeon (KR); Donghan Lee, Daejeon (KR); ChengHao Quan, Yanji City (CN); Gil Young Choi, Daejeon (KR); Cheol Sig Pyo, Daejeon (KR)

Correspondence Address: CANTOR COLBURN, LLP, 20 Church Street, 22nd Floor, Hartford, CT, 06103, US

(73) Assignee: Electronics and Telecommunications Research Institute, Daejeon (KR)

(21) Appl. No.: 12/163,339

(22) Filed: Jun. 27, 2008

(30) Foreign Application Priority Data
Sep. 28, 2007 (KR) 10-2007-0097788

(51) Int. Cl. H04L 7/02

(52) U.S. Cl. 375/360; 340/10.1

(57) ABSTRACT

Disclosed are a method and system for receiving a tag signal in a Radio Frequency Identification (RFID) reader. The method includes generating an edge signal using a tag signal received from an RFID tag; extracting edge information from the generated edge signal, and generating an edge clock corresponding to the extracted edge information; and determining bit data with respect to the tag signal using the generated edge clock.

### CROSS-REFERENCE TO RELATED APPLICATION

This application claims the benefit of Korean Patent Application No. 10-2007-0097788, filed on Sep. 28, 2007, in the Korean Intellectual Property Office, the entire disclosure of which is incorporated herein by reference.

### BACKGROUND OF THE INVENTION

1. Field of the Invention

The present invention relates to a method and system for receiving a tag signal in a Radio Frequency Identification (RFID) reader which determines bit data with respect to a tag signal using an edge signal generated from a received tag signal, thereby obtaining the bit data with reliability with respect to the tag signal regardless of a modulation scheme of the tag signal.

This work was supported by the IT R&D program of MIC/IITA. [2006-S-023-02, Development of Advanced RFID System Technology]

2. Description of Related Art

In general, a Radio Frequency Identification (RFID) refers to a technology which may contactlessly read or record information from a tagged object having a unique identification information using a radio frequency, thereby recognizing, tracing, and managing objects, animals, people, and the like in which a tag is attached. A RFID system may include a plurality of electronic tags or transponders attached on objects, animals, and the like having unique identification information and a RFID reader or interrogator for reading or writing tag information. The RFID system may be divided into a mutual induction scheme and an electromagnetic scheme according to a mutual communication scheme between the RFID reader and the tag, divided into a active type and passive type according to whether the tag is operated by a self-power, and also divided into long wave, medium wave, shortwave, ultrashort wave, and microwave types according to a used frequency.

A tag signal receiving apparatus of a conventional RFID reader may perform an Amplitude-Shift Keying (ASK) demodulation with respect to a tag signal received via an antenna, and determine bit data with respect to the ASK modulated tag signal.

Disadvantageously, the RFID reader described above may be restrictively used only in the ASK demodulation. Specifically, the conventional RFID reader may not be able to cope when the tag signal is changed into a Phase Shift Keying (PSK) scheme, or when ASK and PAK schemes are simultaneously performed.

### SUMMARY OF THE INVENTION

An aspect of the present invention provides a method and system for receiving a tag signal in a Radio Frequency Identification (RFID) reader, which may determine bit data with respect to the tag signal using an edge signal generated from a received tag signal, thereby obtaining bit data with reliability with respect to the tag signal regardless of a modulation scheme of the tag signal.

An aspect of the present invention provides a method and system for receiving a tag signal in an RFID reader, which may determine bit data with superior reliability with respect to the tag signal using a reference level adaptively varying according to the edge signal even when the received tag signal fluctuates due to a Direct Current (DC)-Offset phenomenon, so that tag signal receiving system may be used in an RFID network using a different modulation scheme by receiving tag information of various modulation schemes.

According to an aspect of the present invention, there is provided a tag signal receiving method in an RFID reader, the method including: generating an edge signal using a tag signal received from an RFID tag; extracting edge information from the generated edge signal, and generating an edge clock corresponding to the extracted edge information; and determining bit data with respect to the tag signal using the generated edge clock.

According to an aspect of the present invention, there is provided a tag signal receiving system in an RFID reader, the system including: an edge signal generating unit to generate an edge signal using a tag signal received from an RFID tag; an edge clock generating unit to generate an edge clock corresponding to edge information acquired from the generated edge signal; and a data determining unit to determine bit data to be acquired from the tag signal using the generated edge clock.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is an operational flowchart illustrating a tag signal receiving method in a Radio Frequency Identification (RFID) reader according to an exemplary embodiment of the invention;

FIG. 2 is a diagram illustrating a Miller sub-carrier signal inputted via an I channel of a tag signal receiving system in an RFID reader according to an exemplary embodiment of the invention and a signal in which the tag signal receiving system performs a bandpass filtering with respect to the Miller sub-carrier signal, respectively;

FIG. 3 is a diagram illustrating a Miller sub-carrier signal inputted via a Q channel of a tag signal receiving system in an RFID reader according to an exemplary embodiment of the invention and a signal in which the tag signal receiving system performs a bandpass filtering with respect to the Miller sub-carrier signal, respectively;

FIG. 4 is a waveform diagram illustrating an I channel signal and a first edge signal which are used in a tag signal receiving system in an RFID reader according to an exemplary embodiment of the invention;

FIG. 5 is a waveform diagram illustrating the first edge signal and a reference level signal which are used in a tag signal receiving system in an RFID reader according to an exemplary embodiment of the invention;

FIG. 6 is a diagram illustrating a structure where a second edge signal is generated based on a first edge signal in a tag signal receiving system in an RFID reader according to an exemplary embodiment of the invention;

FIG. 7 is a diagram illustrating tag signals inputted via an I channel and a Q channel affected by an offset phenomenon in a tag signal receiving system in an RFID reader according to an exemplary embodiment of the invention;

FIG. 8 is a diagram illustrating the second edge signal which is robust against an offset phenomenon and noise in a tag signal receiving system in an RFID reader according to an exemplary embodiment of the invention;

FIG. 9 is a diagram illustrating a process where a tag signal receiving system in an RFID reader according to an exemplary embodiment of the invention generates a second edge signal based on a first edge signal using an adaptive reference level signal;

FIG. 10 is a flowchart illustrating a process where a tag signal receiving system in an RFID reader according to an exemplary embodiment of the invention extracts edge information from a second edge signal;

FIG. 11 is a diagram illustrating a process where a tag signal receiving system in an RFID reader according to an exemplary embodiment of the invention determines bit data with respect to a tag signal from an edge clock;

FIG. 12 is a configuration diagram illustrating a configuration of a tag signal receiving system in an RFID reader according to an exemplary embodiment of the invention;

FIG. 13 is a diagram illustrating a configuration of an edge signal generating unit according to an exemplary embodiment of the invention; and

FIG. 14 is a diagram illustrating a configuration of an edge clock generating unit according to an exemplary embodiment of the invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

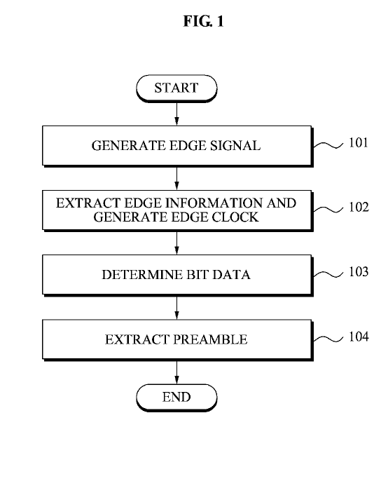

FIG. 1 is an operational flowchart illustrating a tag signal receiving method in a Radio Frequency Identification (RFID) reader according to an exemplary embodiment of the invention.

In operation S101, a tag signal receiving method in the RFID reader according to the present embodiment of the invention may generate an edge signal using a tag signal received from an RFID tag. Specifically, the edge signal is generated using the tag signal in order to determine bit data with respect to the tag signal in operation S101. Here, the edge signal may denote a signal whose slope is changed from negative to positive or vice-versa.

First, the tag signal receiving system performs digital filtering with respect to a I-channel signal and Q-channel signal of the tag signal. Here, the I-channel and Q-channel may denote a sine wave signal indicated in a complex number coordinate.

For example, in the case where the received tag signal is a FMO (bi-phase space) signal, the tag signal receiving system may perform a low-pass filtering with respect to the I-channel signal and Q-channel signal of the tag signal, thereby removing a high-frequency element and a noise element.

In the case where the received tag signal is a Miller sub-carrier signal, the tag signal receiving system may perform a bandpass filtering with respect to the I-channel signal and Q-channel signal of the tag signal, thereby removing undesired low frequency element, high frequency element, noise element, and the like.

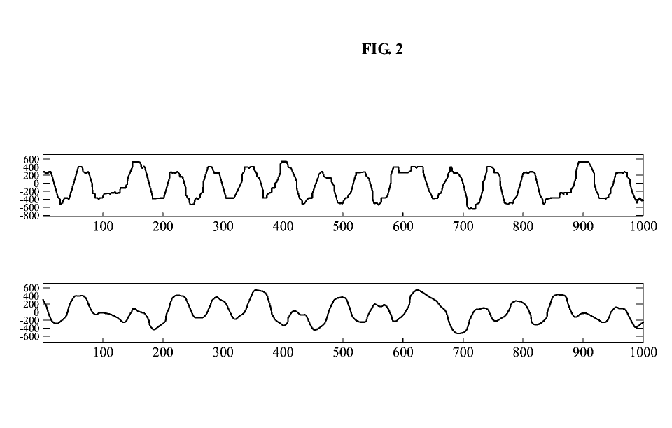

Hereinafter, a process where an edge signal is generated by the tag signal receiving system will be described in detail with reference to FIGS. 2 to 11.

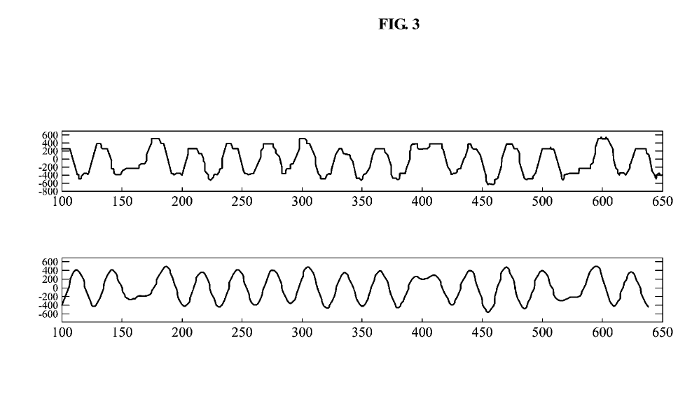

FIG. 2 is a diagram illustrating a Miller sub-carrier signal inputted via an I channel of a tag signal receiving system in an RFID reader according to an exemplary embodiment of the invention and a signal in which the tag signal receiving system performs a bandpass filtering with respect to the Miller sub-carrier signal, respectively, and FIG. 3 is a diagram illustrating a Miller sub-carrier signal inputted via a Q channel of a tag signal receiving system in an RFID reader according to an exemplary embodiment of the invention and a signal in which the tag signal receiving system performs a bandpass filtering with respect to the Miller sub-carrier signal, respectively;

As illustrated in FIGS. 2 and 3, the tag signal receiving system in the RFID reader may perform the bandpass filtering with respect to the I-channel signal and Q-channel signal of the tag signal, that is, the Miller sub-carrier signal. Specifically, the tag signal receiving system may perform the bandpass filtering with respect to the Miller sub-carrier signal, thereby removing an undesired low frequency element, high frequency element, noise element, and the like.

The tag signal receiving system may perform a digital filtering for removing undesired low and high frequency elements and noise elements from the tag signal inputted via an I-channel and Q-channel of the tag signal receiving system, and then apply a matched filter for the purpose of generating an edge signal with respect to the tag signal. Specifically, the tag signal receiving system may make a coefficient of the matched filter match a shape of the tag signal in order to accurately extract the edge signal from the tag signal.

For example, when the tag signal is either the FMO signal or the Miller sub-carrier signal, the coefficient of the matched filter used in generation of the edge signal is represented by the following Equation 1:

$$\begin{matrix}[ Equation 1 ] & \\ {H}_{d} {=}_{norm} [ \frac{4}{π} {\sum }_{i = 1}^{nTerm} \frac{1}{( 2 i - 1 )} \cdot sin ( 2 π \cdot ( 2 i - 1 ) \cdot n / nSamp ) ] , where t = [ 0 nSamp - 1 ] . & ( 1 ) \\ & \end{matrix}$$

Here, the matched filter may denote a filter indicating a maximum output value at the time of input of the corresponding signal since a filter factor is matched with characteristics of a known input signal. In this instance, the matched filter used in the I-channel and Q-channel may use an identical coefficient to Equation 1.

In Equation 1, nTerm is a variable determining a shape of the matched filter, and nSamp is a degree of the matched filter, which is determined to be identical to a number of samples per each symbol for the purpose of demodulation of the received tag signal. The tag signal receiving system changes the value of nTerm according to the shape of the received tag signal to thereby generate an edge signal which is robust against noise and has a uniform magnitude.

Specifically, when the tag signal is inputted to be similar with a rectangular pulse, the tag signal receiving system may increase the value of nTerm, thereby calculating the coefficient of the matched filter to be similar with the shape of the tag signal. Also, when the tag signal is inputted to be close to a sine pulse due to band limitation, the tag signal receiving system may reduce the value of nTerm, thereby calculating the coefficient of the matched filter to be similar with the shape of the tag signal.

The tag signal receiving system may output a first edge signal using the I-channel signal and Q-channel signal in which digital filtering is performed. In this instance, the tag signal receiving system may output the first edge signal using a matched filter of I-channel and Q-channel having a coefficient identical to the above-described coefficient, an absolute value calculator, a square device, a summer, and the like, as well as the I-channel and Q-channel in which the digital filtering is performed.

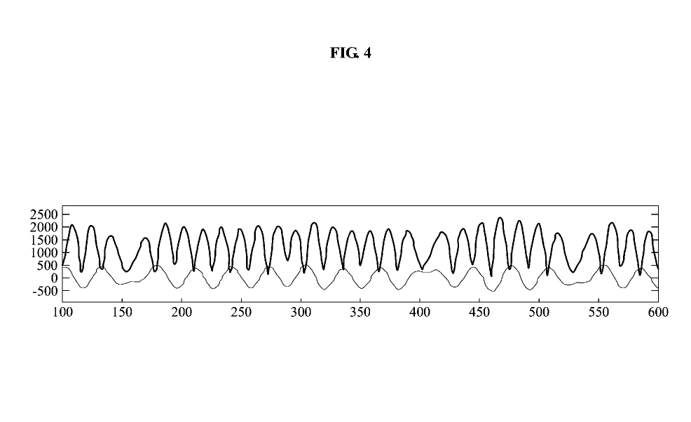

FIG. 4 is a waveform diagram illustrating an I channel signal and a first edge signal which are used in a tag signal receiving system in an RFID reader according to an exemplary embodiment of the invention.

Referring to FIG. 4, the tag signal receiving system may readily generate an edge signal with respect to the tag signal using the matched filter and the absolute value calculator, and the like, and accurately extract an edge element of a tag signal symbol although a Link Frequency (LF) of the tag is changed, thereby improving reliability in decoding tag data and a process speed of the tag signal receiving system.

Next, the tag signal receiving system may generate a second edge signal by removing noise included in a specific level of an outputted first edge signal. In this instance, the tag signal receiving system may retrieve a peak value with respect to the first edge signal outputted at the preceding point in time in a memory, apply a weight to the retrieved peak value to compute a reference peak value, and generate a reference level signal using the computed reference peak value.

Also, the tag signal receiving system may measure a peak value with respect to a first edge signal outputted at a current point in time, and record the measured peak value in the memory.

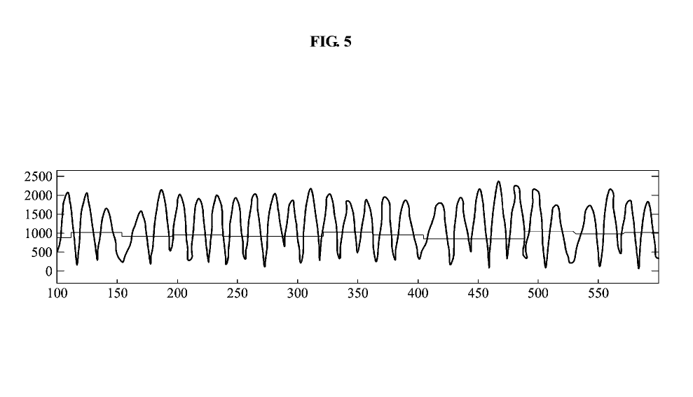

FIG. 5 is a waveform diagram illustrating a first edge signal and an adaptive reference level signal which are used in a tag signal receiving system in an RFID reader according to an exemplary embodiment of the invention.

As illustrated in FIG. 5, the tag signal receiving system may use the adaptive reference level signal in order to remove low-level noise from the first edge signal.

Next, the tag signal receiving system may generate the second edge signal using the generated reference level signal and the first edge signal outputted at the current point in time, thereby removing noise included in the specific level of the first edge signal.

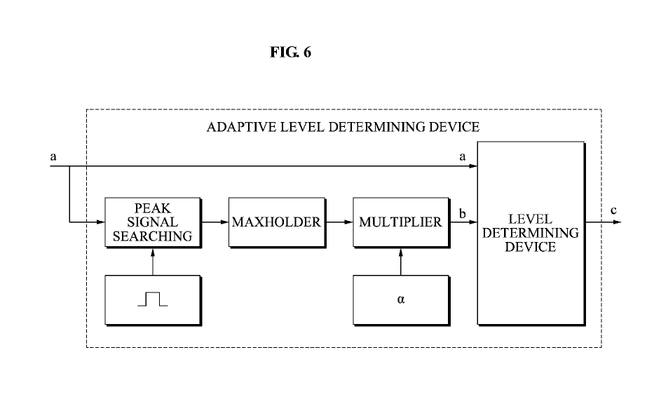

FIG. 6 is a diagram illustrating a state where a second edge signal is generated based on a first edge signal in a tag signal receiving system in an RFID reader according to an exemplary embodiment of the invention.

For example, the tag signal receiving system may extract information about the peak value of the first edge signal (a) in a predefined sample interval, and maintain information with respect to the peak value extracted at the preceding point of time in a predetermined memory. In this instance, a sample interval unit may be preferably 1.5 or 2 folds of a symbol interval and changed according to other environments. Next, the tag signal receiving system may multiply a weight constant to information about the peak value maintained in the predetermined memory using a multiplier to thereby compute a reference peak value, and may generate a reference level signal (b) using the computed reference peak value.

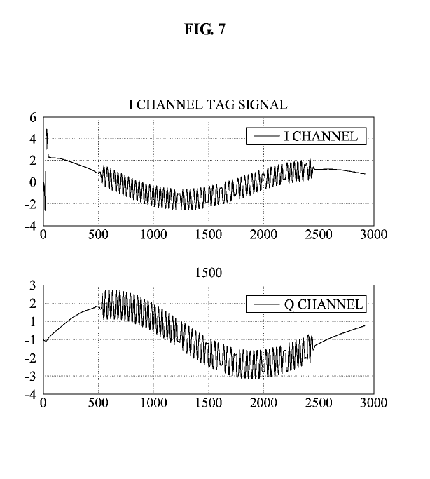

FIG. 7 is a diagram illustrating tag signals inputted via an I-channel and a Q-channel affected by an offset phenomenon in a tag signal receiving system in an RFID reader according to an exemplary embodiment of the invention.

As illustrated in FIG. 7, the tag signal receiving system may be affected by an offset phenomenon to thereby generate an edge signal whose peak values show a big deviation without being maintained in a predetermined value.

The tag signal receiving system can adaptively generate the reference level signal with respect to the edge signal having big deviated peaks, although the received tag signal is distorted by a Direct Current (DC) offset phenomenon and signal fluctuation. This is because that the tag signal receiving system may update the information about the peak value for each fixed sample interval, as described in FIG. 6.

Accordingly, the tag signal receiving system may generate a second edge signal (c) which is robust to the fluctuation of the tag signal and whose noise is removed using the first edge signal (a) and the reference level signal (b).

More specifically, since the tag signal receiving system is required to supply transmission energy (Tx CW) while receiving the tag signal, the transmission energy (Tx CW) element may be leaked to a receiver (Rx). When the leaked transmission energy (Tx CW) element is leaked to a baseband, the DC offset phenomenon is generated in the tag signal receiving system. Thus, when the first edge signal (a) and the second edge signal (c) are generated, the tag signal receiving system may generate the second edge signal (c) while adaptively changing the reference level signal (b) so as to relieve the DC offset phenomenon.

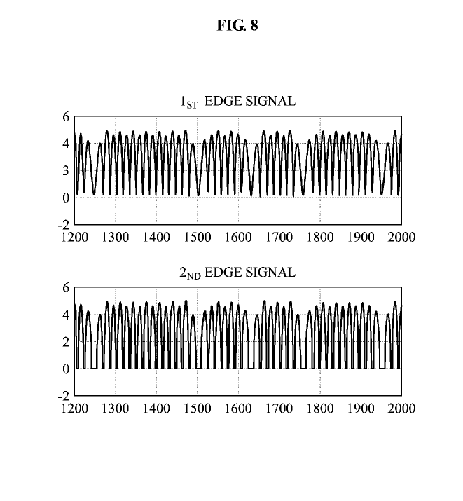

FIG. 8 is a diagram illustrating a second edge signal lightly affected by an offset phenomenon in a tag signal receiving system in an RFID reader according to an exemplary embodiment of the invention.

As illustrated in FIG. 8, the tag signal receiving system may demodulate the second edge signal being robust to fluctuation although the DC offset phenomenon is generated while adaptively changing the reference level signal (b).

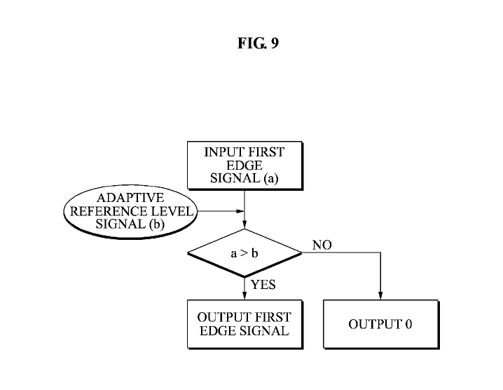

FIG. 9 is a diagram illustrating a process where a tag signal receiving system in an RFID reader according to an exemplary embodiment of the invention generates a second edge signal based on a first edge signal using a reference level signal.

As illustrated in FIG. 9, the tag signal receiving system may output the first edge signal (a) as the second edge signal (c) when a level of the inputted first edge signal (a) is greater than that of the reference level signal (b) (YES of FIG. 9). Conversely, the tag signal receiving system may output ‘0’ as the second edge signal (c), when the level of the inputted first edge signal (a) is less than that of the reference level signal (b) (NO of FIG. 9).

In this manner, the tag signal receiving system may update the second edge signal by removing low level noise contaminated in the first edge signal using the calculated reference level. Therefore, the tag signal receiving system can successfully extract edge information from the second edge signal without an error.

Referring again to FIG. 2, in operation S102, the tag signal receiving system may extract the edge information from the generated edge signal, and generate the edge clock corresponding to the extracted edge information. Specifically, operation S102 is a process where the tag signal receiving system extracts the edge information, that is, information about an edge (position where a slope is changed from positive to negative or vice-versa) from the edge signal generated from the tag signal, and generates the edge clock enabled at a position according to the extracted edge information (position where the slope is changed from positive to negative or vice-versa).

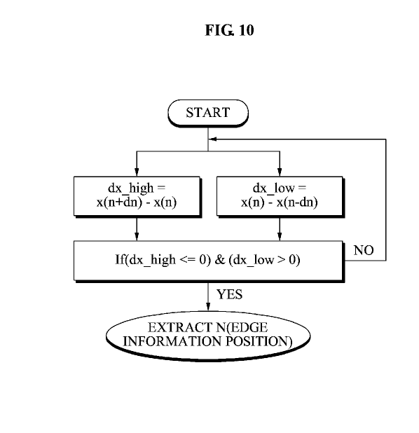

Hereinafter, a process where the edge information is extracted by the tag signal receiving system with reference to FIG. 10.

FIG. 10 is a flowchart illustrating a process where a tag signal receiving system in an RFID reader according to an exemplary embodiment of the invention extracts edge information from a second edge signal.

As illustrated in FIG. 10, the tag signal receiving system may compute an amplitude value with respect to an edge signal at a plurality of points in time being consecutive on a basis of a current point in time, calculate a minimum reference value based on the second amplitude value (Xn) associated with a second point in time and the first amplitude value (X(n−dn)) associated with a first point in time prior to the second point in time, and calculate a maximum reference value base on the second amplitude value (Xn) and the third amplitude value (X(n+dn)) associated with a third point in time after the second point in time. Also, the tag signal receiving system may verify occurrence of a peak value in which a slope of the generated edge signal is changed from positive to negative using the calculated minimum reference value and maximum reference value, and extract the edge information from the edge signal according to the verification of the occurrence of the peak value.

The tag signal receiving system may extract edge information about portions where the maximum reference value (dx_high) is less than or equal to ‘0’ and the minimum reference value (dx_low) is greater than ‘0’ (YES of FIG. 10), and where a slope of the second edge signal is changed from positive to negative. Conversely, the tag signal receiving system may repeatedly calculate the maximum reference value and the minimum reference value until the maximum reference value (dx_high) is less than or equal to ‘0’, and the minimum reference value (dx_low) is greater than ‘0’ in the case where the maximum reference value (dx_high) is greater than ‘0’ or the minimum reference value (dx_low) is less than or equal to ‘0’ (NO of FIG. 10).

For example, the tag signal receiving system may extract edge information about a portion where the slope of the second edge signal is changed from positive to negative when the maximum reference value is ‘−1’, and the minimum reference value is ‘3’. Conversely, the tag signal receiving system may repeatedly calculate the maximum reference value and the minimum reference value until the maximum reference value is equal to or less than ‘0’, and the minimum reference value is greater than ‘0’ when the maximum reference value is ‘3’, and the minimum reference value is ‘−1’.

Also, as illustrated in FIG. 10, dn=1 from dn=1,2,3, . . . may denote the preceding sample value, and dn=2 may denote a sample value prior to two samples. As a result, the tag signal receiving system may determine another sample interval even though a noise signal is present in a local peak of the second edge signal, thereby avoiding the local peak interval where a noise signal is generated.

In operation S103, the tag signal receiving system may determine bit data with respect to the tag signal using the generated edge clock. Operation S103 is a process where the tag signal receiving system may estimate a pulse width of data restored using the edge clock to thereby determine the bit data with respect to the tag signal using the edge clock.

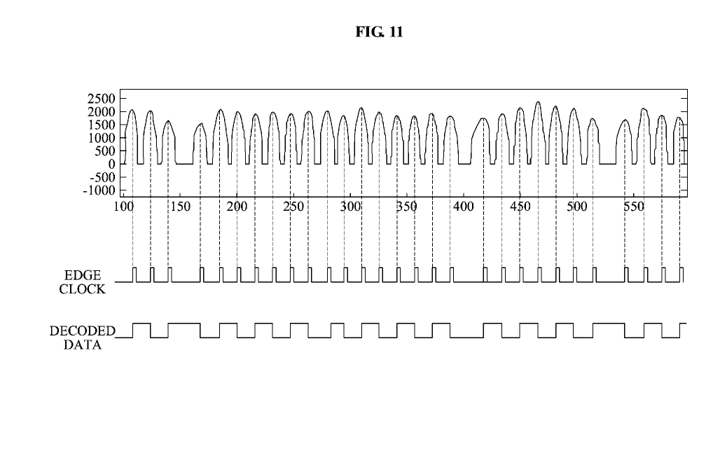

Hereinafter, a process where bit data is determined by the tag signal receiving system with reference to FIG. 11 will be described in detail.

FIG. 11 is a diagram illustrating a process where a tag signal receiving system in an RFID reader according to an exemplary embodiment of the invention determines bit data with respect to a tag signal from the extracted edge clock.

The tag signal receiving system may determine the bit data with respect to the tag signal from the edge clock. In this instance, the tag signal receiving system may estimate a pulse width of data restored by an input of the edge clock, and determine the bit data according to the estimated result.

For example, the tag signal receiving system may determine the restored data having a narrow pulse width into bit 0 and the restored data having a wide pulse width into bit 1.

In operation S104, the tag signal receiving system may extract a preamble of the tag signal based on the determined bit data. Operation S104 is a process where the tag signal receiving system may extract, from the determined bit data, a preamble including information about the start of effective specific data.

Accordingly, the tag signal receiving system may determine the bit data with respect to the tag signal using the edge signal generated from the received tag signal, thereby preparing a system for obtaining bit data with reliability with respect to the tag signal regardless of modulation schemes of the tag signal.

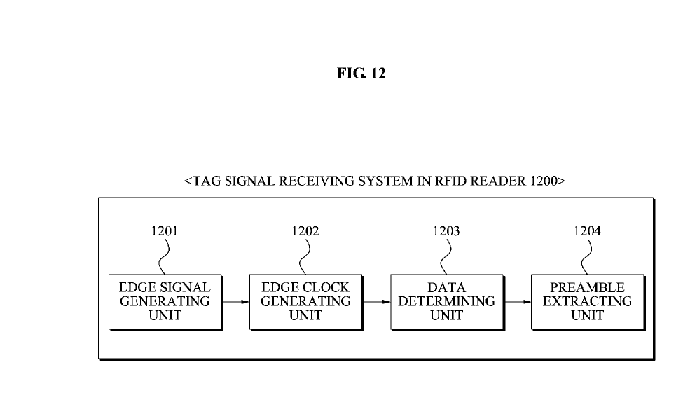

FIG. 12 is a configuration diagram illustrating a configuration of a tag signal receiving system 1200 in an RFID reader according to an exemplary embodiment of the invention.

The tag signal receiving system 1200 may include an edge signal generating unit 1201, an edge clock generating unit 1202, a data determining unit 1203, and a preamble extracting unit 1204.

The edge signal generating unit 1201 may generate an edge signal using a tag signal received from an RFID tag. Specifically, the edge signal generating unit 1201 may generate the edge signal using the tag signal so as to determine the bit data with respect to the tag signal received from the RFID tag.

First, the edge signal generating unit 1201 may perform digital filtering with respect to an I-channel signal and Q-channel signal of the tag signal.

For example, when the received tag signal is the FMO signal, the edge signal generating unit 1201 may perform a low-pass filtering with respect to the I-channel signal and Q-channel signal of the tag signal, thereby removing a high frequency element and a noise element included in the I-channel signal and Q-channel signal of the tag signal.

When the received tag signal is the Miller sub-carrier signal, the edge signal generating unit 1201 may perform the bandpass filtering with respect to the I-channel signal and Q-channel signal of the tag signal, thereby removing undesired low-frequency and high-frequency elements and noise element.

Next, the edge signal generating unit 1201 may make coefficients of the matched filter applied in generation of the edge signal match each other. Specifically, the edge signal generating unit 1201 may make coefficients of the matched filter match a shape of the tag signal in order to appropriately extract the edge signal from the tag signal.

For example, when the tag signal is either the FM0 signal or the Miller sub-carrier signal, the coefficient of the matched filter used in generation of the edge signal is represented by the following Equation 2:

$$\begin{matrix}[ Equation 2 ] & \\ {H}_{d} {=}_{norm} [ \frac{4}{π} {\sum }_{i = 1}^{nTerm} \frac{1}{( 2 i - 1 )} \cdot sin ( 2 π \cdot ( 2 i - 1 ) \cdot n / nSamp ) ] , where t = [ 0 nSamp - 1 ] . & ( 2 )\end{matrix}$$

Specifically, when the tag signal is inputted to be similar with a rectangular pulse, the edge signal generating unit 1201 may increase a value of nTerm, thereby calculating the coefficient of the matched filter to be similar with the shape of the tag signal. Also, when the tag signal is inputted to be close to a sine pulse due to band limitation, the edge signal generating unit 1201 may reduce the value of nTerm, thereby calculating the coefficient of the matched filter to be similar with the shape of the tag signal.

The edge signal generating unit 1201 may output a first edge signal using an I-channel signal and Q-channel signal in which digital filtering is performed. In this instance, the edge signal generating unit 1201 may output the first edge signal using the matched filter of I-channel and Q-channel having a coefficient identical to the above-described coefficient, an absolute value calculator, a square device, a summer, and the like, as well as the I-channel and Q-channel in which the digital filtering is performed.

The edge signal generating unit 1201 may readily generate an edge signal with respect to the tag signal using the matched filter and the absolute value calculator, and the like, and accurately extract an edge element of a tag signal symbol although an LF of the tag is changed, thereby improving reliability in decoding tag data and a process speed of the tag signal receiving system.

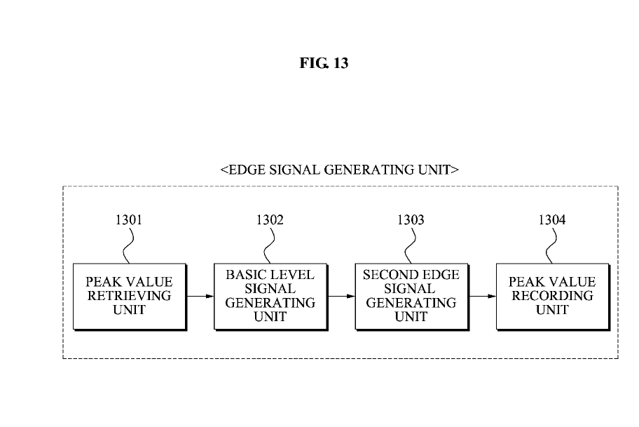

Next, the edge signal generating unit 1201 may generate a second edge signal by removing noise included in a specific level of an outputted first edge signal. Hereinafter, the edge signal generating unit 1201 will be described in detail with reference to FIG. 13.

FIG. 13 is a diagram illustrating a configuration of the edge signal generating unit 1201 of FIG. 12.

Referring to FIG. 13, the edge signal generating unit 1201 may include a peak value retrieving unit 1301, a reference level signal generating unit 1302, a second edge signal generating unit 1303, and a peak value recording unit 1304.

The peak value retrieving unit 1301 may retrieve a peak value with respect to a first edge signal outputted at the preceding point in time in a predetermined memory, and the reference level signal generating unit 1302 may apply a weight to the retrieved peak value to compute a reference peak value, and generate a reference level signal using the computed reference peak value.

The second edge signal generating unit 1303 may generate a second edge signal using the first edge signal generated at a current point in time and the generated reference level signal, thereby removing noise included in a specific level of the first edge signal.

The peak value recording unit 1304 may measure a peak value with respect to the first edge signal outputted at the current point in time and record the measured peak value in a memory.

For example, the peak value retrieving unit 1301 may extract information about the peak value of the first edge signal (a) in a predefined sample interval, and then the extracted peak value is used to calculate a reference level in the next sample interval.

The peak value recording unit 1304 may maintain information about the peak value extracted in a predetermined memory during the fixed sample interval.

Next, the reference level signal generating unit 1302 may multiply a weight constant to information about the peak value maintained in the predetermined memory using a multiplier to thereby compute a reference peak value, and may generate a reference level signal (b) using the computed reference peak value.

Accordingly, the second edge signal generating unit 1303 may generate a second edge signal (c) which is robust against the DC offset phenomenon and fluctuation of the tag signal and whose noise is removed, using the first edge signal (a) and the reference level signal (b).

The second edge signal generating unit 1303 may output the first edge signal (a) as the second edge signal (c) when a level of the inputted first edge signal (a) is greater than that of the reference level signal (b). Conversely, the second edge signal generating unit 1303 may output ‘0’ as the second edge signal (c) when the inputted first edge signal (a) is less than that of the reference level signal (b).

In this manner, the tag signal receiving system may update the second edge signal by removing low level noise contaminated in the first edge signal using the calculated reference level. Therefore, the tag signal receiving system can successfully extract edge information from the second edge signal without an error.

The edge clock generating unit 1202 may extract edge information from the generated edge signal, and generate an edge clock corresponding to the extracted edge information. Specifically, the edge clock generating unit 1202 may extract edge information, that is, information about an edge (position where a slope is changed from positive to negative or vice-versa) from the edge signal generated from the tag signal, and generate an edge clock enabled in a position according to the extracted edge information (position where the slope is changed from positive to negative or inversely).

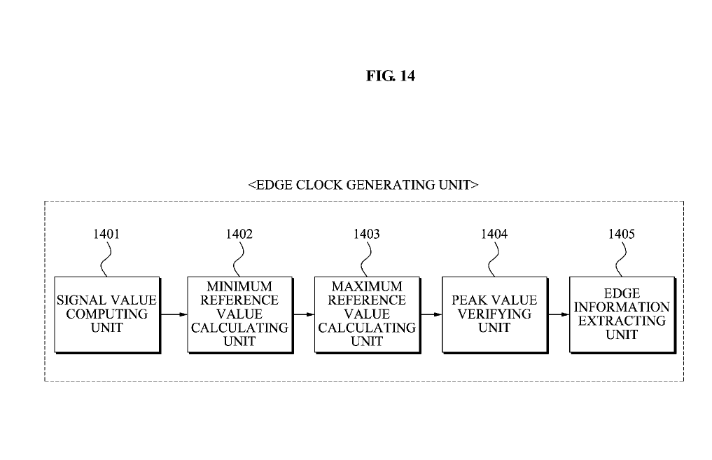

Hereinafter, the edge clock generating unit 1202 will be described in detail with reference to FIG. 14.

FIG. 14 is a diagram illustrating a configuration of the edge clock generating unit 1202 of FIG. 12.

Referring to FIG. 14, the edge clock generating unit 1202 may include a signal value computing unit 1401, a minimum reference value calculating unit 1402, a maximum reference value calculating unit 1403, a peak value verifying unit 1404, and an edge information extracting unit 1405.

The signal value computing unit 1401 may compute an amplitude value with respect to an edge signal at a plurality of points in time being consecutive on a basis of a current point in time.

The minimum reference value calculating unit 1402 may calculate a minimum reference value (dx_low) based on the second amplitude value (X(n)) associated with a second point in time and the first amplitude value (X(n−dn)) associated with a first point in time prior to the second point in time.

The maximum reference value calculating unit 1403 may calculate a maximum reference value (dx_high) based on the second amplitude value (X(n)) and the third amplitude value (X(n+dn)) associated with a third point in time after the second point in time.

The peak value verifying unit 1404 may verify occurrence of a peak value in which a slope of the generated edge signal is changed from positive to negative using the calculated minimum reference value and maximum reference value.

The edge information extracting unit 1405 may extract the edge information from the edge signal according to the verification of the occurrence of the peak value.

The data determining unit 1203 may determine bit data with respect to the tag signal using the generated edge clock. Specifically, the data determining unit 1203 may estimate a pulse width of data restored using the edge clock, and determine the bit data with respect to the tag signal.

The preamble extracting unit 1204 may extract a preamble of the tag signal based on the determined bit data. Specifically, the preamble extracting unit 1204 may extract, from the determined bit data, a preamble including information about start of effective specific data.

As described above, according to the present invention, the bit data with respect to the tag signal is obtained using the edge signal generated from the received tag signal, thereby determining bit data with reliability with respect to the tag signal regardless of a modulation scheme of the tag signal.

According to the present invention, the bit data with superior reliability with respect to the tag signal is obtained using the reference level adaptively varying according to the edge signal even when the received tag signal fluctuates due to the DC-Offset phenomenon, so that the bit data may be used in an RFID network using a different modulation scheme by receiving tag information of various modulation schemes.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A tag signal receiving method in an RFID reader, the method comprising:
generating an edge signal using a tag signal received from an RFID tag;
extracting edge information from the generated edge signal, and generating an edge clock corresponding to the extracted edge information; and
determining bit data with respect to the tag signal using the generated edge clock.

2. The tag signal receiving method of claim 1, further comprising:
extracting a preamble of the tag signal based on the determined bit data.

3. The tag signal receiving method of claim 1, wherein the generating of the edge signal includes:
performing digital filtering with respect to a I-channel signal and Q-channel signal of the tag signal; and
outputting a first edge signal using the digital filtered I-channel and Q-channel signals.

4. The tag signal receiving method of claim 3, wherein the outputting of the first edge signal includes:
making coefficients of filters agree with each other, the filters being applied to the generation of the edge signal.

5. The tag signal receiving method of claim 3, wherein the generating of the edge signal further includes:
removing noise included in a specific level of the outputted first edge signal to generate a second edge signal.

6. The tag signal receiving method of claim 3, wherein the generating of the edge signal further includes:
retrieving a peak value with respect to the first edge signal outputted at the preceding point in time in a memory;
applying a weight to the retrieved peak value to compute a reference peak value, and generating a reference level signal using the computed reference peak value; and
generating a second edge signal using the generated reference level signal and the first edge signal outputted at a current point in time.

7. The tag signal receiving method of claim 6, wherein the generating of the edge signal further includes:
measuring the peak value with respect to the first edge signal outputted at the current point in time to record the measured peak value in the memory

8. The tag signal receiving method of claim 1, wherein the generating of the edge clock includes:
computing an amplitude value with respect to an edge signal at a plurality of points in time being consecutive on a basis of a current point in time;
calculating a minimum reference value based on the second amplitude value associated with the second point in time and the first amplitude value associated with the first point in time prior to the second point in time;
calculating a maximum reference value based on the second amplitude value and the third amplitude value associated with the third point in time after the second point in time;
verifying occurrence of a peak value in which a slope of the generated edge signal is changed from positive to negative using the calculated minimum reference value and maximum reference value; and
extracting the edge information from the edge signal according to the verification of the occurrence of the peak value.

9. The tag signal receiving method of claim 1, wherein the determining of the bit data includes:
measuring a pulse width of data restored by an input of the edge clock; and
determining the bit data according to the measured result.

10. A tag signal receiving system in an RFID reader, the system comprising:
an edge signal generating unit to generate an edge signal using a tag signal received from an RFID tag;
an edge clock generating unit to generate an edge clock corresponding to edge information acquired from the generated edge signal; and
a data determining unit to determine bit data to be acquired from the tag signal using the generated edge clock.

11. The tag signal receiving system of claim 10, further comprising:
a preamble extracting unit to acquire a preamble of the tag signal based on the determined bit data.

12. The tag signal receiving system of claim 10, wherein the edge signal generating unit includes:
a peak value retrieving unit to retrieve a peak value with respect to a first edge signal outputted from a predetermined memory at the preceding point in time;
a reference level signal generating unit to apply a weight to the retrieved peak value to compute a reference peak value, and generate a reference level signal using the computed reference peak value; and
a second edge signal generating unit to generate a second edge signal using the first edge signal generated at a current point in time and the generated reference level signal.

13. The tag signal receiving system of claim 12, wherein the edge signal generating unit further includes:
a peak value recording unit to measure a peak value with respect to the first edge signal at the current point in time.

14. The tag signal receiving system of claim 10, wherein the edge clock generating unit includes:
a signal value computing unit to compute a signal value with respect to an edge signal at a plurality of points in time being consecutive on a basis of a current point in time;
a minimum reference value calculating unit to calculate a minimum reference value based on the second amplitude value associated with a second point in time and the first amplitude value associated with the first point in time prior to the second point in time;
a maximum reference value calculating unit to calculate a maximum reference value based on the second amplitude value and the third amplitude value associated with the third point in time after the second point in time;
a peak value verifying unit to verify occurrence of a peak value in which a slope of the generated edge signal is changed from positive to negative using the calculated minimum reference value and maximum reference value; and
an edge information extracting unit to extract the edge information from the edge signal according to the verification of the occurrence of the peak value.
